(19) United States
(12) Patent Application Publication
(10) Pub. No.: US 2018/0321570 A1
(43) Pub. Date: Nov. 8, 2018

(54) Integrated Electro-Optic Modulator and Method of Improving 3dB Bandwidth Thereof by Means of Substrate Hollowing Out

(71) Applicant: WUHAN RESEARCH INSTITUTE OF POSTS AND TELECOMMUNICATIONS, Wuhan City, Hubei Province (CN)

(72) Inventors: MIAOFENG LI, Wuhan City, Hubei Province (CN); XI XIAO, Wuhan City, Hubei Province (CN); LEI WANG, Wuhan City, Hubei Province (CN)

(21) Appl. No.: 16/063,288

(22) PCT Filed: Dec. 7, 2016
(86) PCT No.: PCT/CN2016/108959

§ 371 Date: Jun. 17, 2018

(30) Foreign Application Priority Data
Dec. 21, 2015 (CN) 201510970874.4

(51) Int. Cl. G02F 1/225; G02F 1/01; G02F 1/035

(52) U.S. Cl. CPC G02F 1/2255; G02F 1/0356; G02F 1/0121

(57) ABSTRACT

An integrated electro-optic modulator and a method of improving 3 dB bandwidth thereof by substrate hollowing. The method comprises the steps of: calculating an electric field intensity distribution area on the cross section of a modulation area of the integrated electro-optic modulator (101); taking an overlapping part of the electric field intensity distribution area and a substrate material (10) as a hollowing out area (80) (102); determining a size and positions of hollowing out windows (60) needing to be opened in a buried layer of silicon dioxide (20) over the hollowing out area (80) beside both sides of electrodes (50), and etching out the hollowing out windows (60) (103); and performing a hollowing operation on the hollowing out area (80) via the hollowing out windows (60) (104).

### TECHNICAL FIELD

The present invention relates to the field of optical communication integrated devices, and more particularly, to an integrated electro-optic modulator and a method of improving 3 dB bandwidth thereof by means of substrate hollowing out.

### BACKGROUND ART

With the continuous progress and development of the society, the demand of people on information is higher and higher, resulting in exponential burst growth of the information data quantity. The rapid development of the optical communication network technology provides a reliable and effective scheme for solving the problem. An electro-optic modulator is one of the core devices of an entire optical communication network and is responsible for converting an electrical signal into an optical signal which can be transmitted in the optical communication network. The traditional lithium niobate-based electro-optic high-speed modulators are often large in appearance size, on the order of 5-10 cm, and also relatively large in the power consumption. These defects are obviously adverse to the miniaturization and energy conservation of a communication system. Therefore, the study of an optical modulator featured by high modulation bandwidth, high extinction ratio, low power consumption, easy integration and low cost is of important practical significance.

At present, an integrated electro-optic modulator is generally processed based on two material systems of silicon-based or three-family semiconductors, and for the integrated electro-optic modulators, in order to enable the optical communication network to have larger capacity; the 3 dB bandwidth thereof needs to be continuously improved. For an integrated electro-optic modulator of a travelling wave electrode structure which is generally adopted at present, under the conditions of matched electrode microwave impedance and matched electro-optic refractive index, its 3 dB bandwidth is mainly restricted by the following factors:

(1) Loss of microwave signals caused by characteristics such as capacitance resistance and the like of electro-optic action media of the electro-optic modulation interaction area of the integrated electro-optic modulator;

(2) Microwave loss caused by parasitic parameters of the traveling wave electrodes of the integrated electro-optic modulator;

(3) Microwave absorption loss caused by the substrate dielectric material of the entire integrated electro-optic modulator.

Among the three factors bringing loss and further causing the 3 dB bandwidth of the integrated electro optical modulator to be reduced, the factor (1) is difficult to further limit and decrease due to the limitations of the intrinsic modulation mechanism and the balance of performance parameters of the integrated electro-optic modulator. Thus, to achieve great improvement, it is desired to effectively improve and design the active area. The factor (2) can be further improved by adopting more advanced electrode structure and optimized electrode parameters. The factor (3) is mainly improved by improving the resistivity of the substrate material at present. For example, a high-resistance substrate is adopted to replace the original substrate material. If the loss of the substrate can be further reduced through a certain scheme, the 3 dB bandwidth of the integrated electro-optic modulator can be further improved. In view of the above, it is urgent to provide a new method of manufacturing an integrated electro-optic modulator such that the microwave absorption loss caused by the use of a high-resistance substrate for an existing integrated electro-optic modulator is reduced and the 3 dB bandwidth of the existing integrated electro optical modulator is increased.

### SUMMARY OF THE INVENTION

The technical problem to be solved by the present invention is how to reduce the microwave absorption loss caused by the use of a high-resistance substrate for an integrated electro-optic modulator so as to increase the 3 dB bandwidth of the integrated electro-optic modulator.

To solve the above technical problem, the technical solution adopted for the present invention is to provide an integrated electro-optic modulator, comprises a substrate material, a buried layer of silicon dioxide, an active area, a covering layer of silicon dioxide, and two electrodes.

The substrate material is located at the bottom layer and covered with the buried layer of silicon dioxide. The active area is disposed at the center of the buried layer of silicon dioxide. The covering layer of silicon dioxide covers the active area on the buried layer of silicon dioxide. The two electrodes are disposed on the buried layer of silicon dioxide. The active area is shaped like a step with the middle protruding. A plurality of hollowing out windows are etched in the buried layer of silicon dioxide. The two electrodes are connected to the step surface of the active area via two through holes, respectively.

The substrate material comprises a hollowing out area and a non-hollowing out area. The hollowing out area is an overlapping part of an electric field intensity distribution area on the cross section of a modulation area of the integrated electro-optic modulator and the substrate material, and the rest of the substrate material is the non-hollowing out area.

In the above technical solution, the hollowing out windows are etched by using an anisotropic etching process, and the hollowing out area is hollowed out via the hollowing window using an hollowing out operation.

In the above technical solution, a non-etched part is left between the hollowing out windows as a supporting beam.

In the above technical solution, the hollowing out operation is performed on the hollowing out area by using an isotropic etching process or a wet etching process. In the above technical solution, the shape of the hollowing out windows includes but is not limited to square, round, oval, trapezoid, and triangle.

The present invention also provides a method of improving 3 dB bandwidth of an integrated electro-optic modulator by substrate hollowing, the method comprising the steps of:

calculating an electric field intensity distribution area on the cross section of a modulation area of the integrated electro-optic modulator by electromagnetic field simulation analysis software;

taking an overlapping part of the electric field intensity distribution area and the substrate material as the hollowing out area;

determining a size and positions of the hollowing out windows needing to be opened in the buried layer of silicon dioxide over the hollowing out area beside both sides of the electrodes, and etching out the hollowing out windows; and

performing a hollowing out operation on the hollowing out area via the hollowing out windows.

In the above technical solution, the hollowing out windows are etched by using an anisotropic etching process.

In the above technical solution, a non-etched part is left between the hollowing out windows as a supporting beam.

In the above technical solution, the hollowing out operation is performed on the hollowing out area by using an isotropic etching process or a wet etching process. In the above technical solution, the shape of the hollowing out windows includes but is not limited to square, round, oval, trapezoid, and triangle.

According to the present invention, the electric field intensity distribution area on the cross section of the modulation area of the integrated electro-optic modulator is calculated and the overlapping part of the electric field intensity distribution area and the substrate material is taken as the hollowing out area. Moreover, the hollowing out windows are opened in the buried layer of silicon dioxide so that the hollowing operation can be performed on the hollowing out area. Thus, the loss of a signal on the electrodes caused by the substrate material may be reduced to an extremely low level and the 3 dB bandwidth of the integrated electro-optic modulator may be significantly increased.

### BRIEF DESCRIPTION OF THE DRAWINGS

FIG. 1 is a flowchart of a method of improving 3 dB bandwidth of an integrated electro-optic modulator by substrate hollowing according to an embodiment of the present invention.

FIG. 2 is a structural schematic diagram of a silicon-based integrated electro-optic modulator according to an embodiment of the present invention.

FIG. 3 is a diagram of a calculation result of distribution, on a Silicon-on-Insulator cross section, of electrical field intensities on the cross section of a modulation area of a silicon-based integrated electro-optic modulator according to an embodiment of the present invention.

FIG. 4 is a schematic diagram of an overlapping part of electrical field intensities on the cross section of a modulation area of a silicon-based integrated electro-optic modulator and a silicon substrate according to an embodiment of the present invention.

FIG. 5 is a cross-sectional structural schematic diagram of a silicon-based integrated electro-optic modulator with a non-hollowed-out silicon substrate according to an embodiment of the present invention.

FIG. 6 is a top view of hollowing out windows opened in a buried layer of silicon dioxide according to an embodiment of the present invention.

FIG. 7 is a cross-sectional structural schematic diagram of the part of hollowing out windows opened in a buried layer of silicon dioxide according to an embodiment of the present invention.

### DETAILED DESCRIPTION OF THE INVENTION

A physical mechanism of loss caused by the use of a high-resistance substrate for an integrated electro-optic modulator is as follows:

When a high-frequency microwave signal is transmitted on electrodes, the electromagnetic field thereof is mainly bound in a metal dielectric area between the electrodes to form a propagating electromagnetic field for forward propagation. For a general integrated electro-optic modulator, a microwave electromagnetic field of a signal transmitted on the electrodes mainly interacts with three layers of materials, i.e., a surface covering layer of the electrodes, an active modulation area and a substrate material layer. The layer of material covering the surface of the electrode is generally air, silicon dioxide or other materials with low electrical conductivity, so that the attenuation effect of the material on the signal is limited. The active area is located in the middle layer. Since the active area is limited by a material system and a modulation structure, it is difficult to reduce the electrical conductivity thereof and further reduce the loss of a signal although certain loss exists. The substrate material located at the bottom layer of the entire integrated electro-optic modulator generally has the thickness of about 500 microns. The substrate is generally made of a semiconductor material, and the general conductivity of the substrate material is higher than that of silicon dioxide and other insulators, so that the substrate material can bring great loss to a signal on the electrodes, thereby reducing the bandwidth of the integrated electro-optic modulator. Therefore, the 3 dB bandwidth of the integrated electro-optical modulator can be improved by eliminating or greatly reducing the above loss factor. According to the invention, the substrate material is hollowed out, so that the loss of a signal on the electrodes by the substrate material can be reduced to a very low level, thus significantly improving the 3 dB bandwidth of the integrated electro-optic modulator with the substrate material.

The present invention will be described below in detail in conjunction with the drawings accompanying the description and specific embodiments.

An embodiment of the present invention provides a method of improving 3 dB bandwidth of an integrated electro-optic modulator by hollowing out a substrate. As shown in FIG. 1, the method includes the following steps.

Step S101, An electric field intensity distribution area on the cross section of a modulation area of the integrated electro-optic modulator is calculated by electromagnetic field simulation analysis software.

Step S102, An overlapping part of the electric field intensity distribution area and a substrate material is taken as a hollowing out area.

Step S103, A size and positions of hollowing out windows needing to be opened are determined in the buried layer of silicon dioxide over the hollowing out area beside both sides of the electrodes. Specifically, the size and positions of the hollowing out windows needing to be opened may be determined with no damage to the structure of an active area and electrodes, and the hollowing out windows are etched out.

Step S104, A hollowing out operation is performed on the hollowing out area via the hollowing out windows without damaging the structure of other layers.

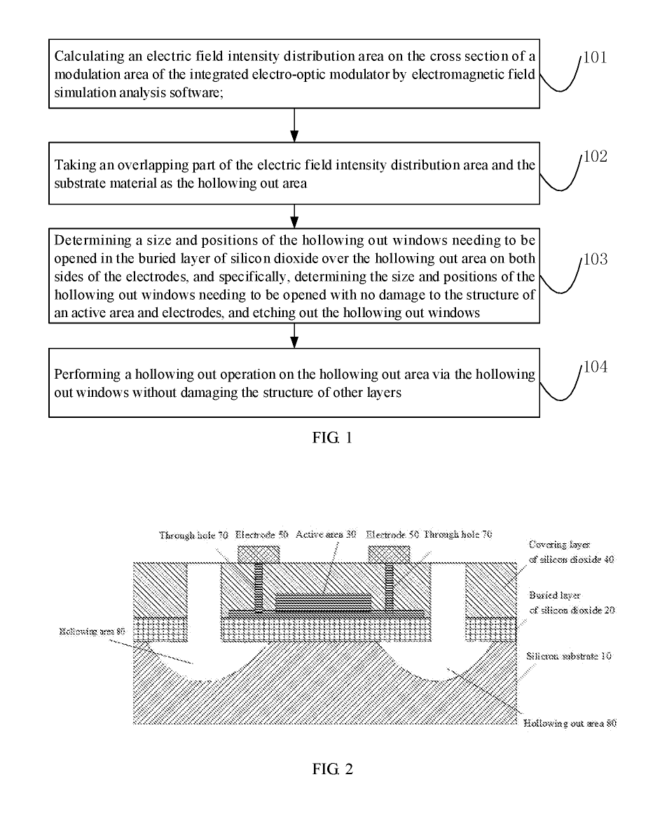

As shown in FIG. 2, an embodiment of the present invention also provides an integrated electro-optic modulator, for example, a silicon-based integrated electro-optic modulator, comprises a silicon substrate 10, a buried layer of silicon dioxide 20, an active area 30, a covering layer of silicon dioxide 40, and two electrodes 50.

The silicon substrate 10 is located at the bottom layer and covered with one buried layer of silicon dioxide 20. The active area 30 is disposed at the center of the buried layer of silicon dioxide 20. The covering layer of silicon dioxide 40 covers the active area 30 on the buried layer of silicon dioxide 20. The two electrodes 50 are disposed on the buried layer of silicon dioxide 20. The active area 30 is shaped like a step with the middle protruding. A plurality of hollowing out windows 60 are etched in the buried layer of silicon dioxide 20. The two electrodes 50 are connected to the step surface of the active area 30 via two through holes 70, respectively.

The silicon substrate 10 is hollowed out via the hollowing out windows 60 so that a hollowing out area 80 is formed in the silicon substrate 10. The hollowing out area 80 is an overlapping part of an electric field intensity distribution area on the cross section of a modulation area of the silicon-based integrated electro-optic modulator and the silicon substrate 10.

The specific implementation process of the method of the present invention will be illustrated below by taking the silicon-based integrated electro-optic modulator for example.

According to the present invention, firstly, electric field intensity distribution data on the cross section of a modulation area of the entire silicon-based integrated electro-optic modulator is calculated by a numerical simulation calculation method. In general, the active area of the entire silicon-based integrated electro-optic modulator on the cross section is uniformly distributed, and the distribution of electric field intensities can be obtained through calculation by electromagnetic field simulation analysis software.

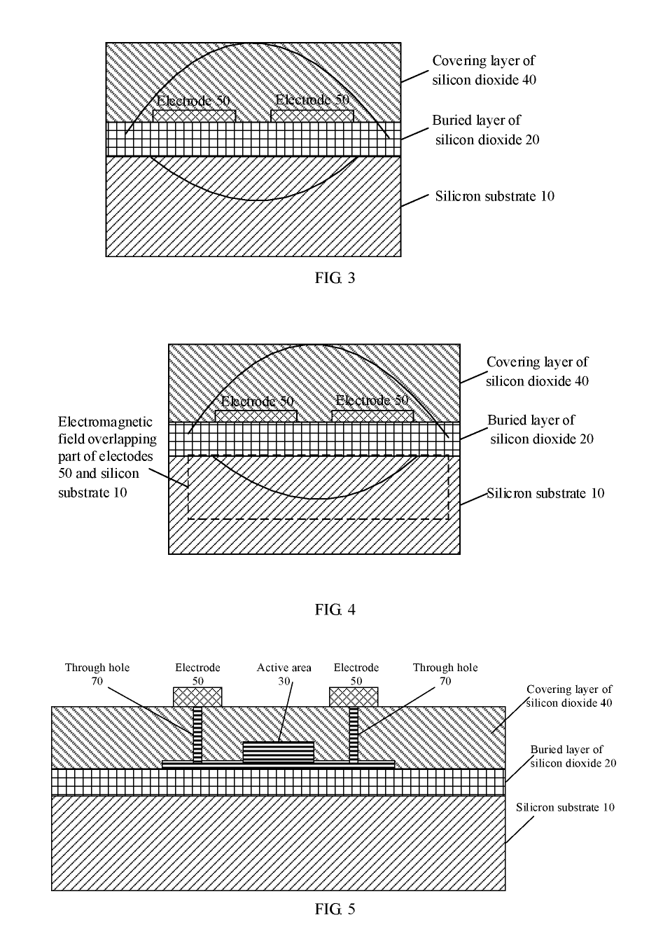

After obtaining the electric field intensity distribution result on the cross section of the silicon-based integrated electro-optic modulator, a distribution of electric field intensities on SOI on the cross section as shown in FIG. 3 can be obtained by drawing the electric field intensity distribution and a cross-sectional structure of Silicon-On-Insulator (SOI) for manufacturing the silicon-based integrated electro-optic modulator in the same coordinates. This distribution is also the actual distribution of electric field intensities on the cross section of the entire silicon-based integrated electro-optic modulator when the silicon-based integrated electro-optic modulator is in working condition.

After obtaining the distribution range of electric field intensities, it is required to compare the distribution range with the silicon substrate 10 in the silicon-based integrated electro-optic modulator to obtain an electromagnetic field overlapping part of the silicon substrate 10 and electrodes 50. The schematic diagram of the overlapping part is as shown in FIG. 4, where the overlapping part in the dashed box is the part causing loss of a signal in the silicon substrate 10. Therefore, this overlapping part is taken as the area 80 to be hollowed out. Thus, the loss can be reduced just by removing a loss dielectric in the area 80 to be hollowed out, and then the 3 dB bandwidth of the silicon-based integrated electro-optic modulator can be increased.

As shown in FIG. 5, it is a cross-sectional structural schematic diagram of a silicon-based integrated electro-optic modulator with a non-hollowed-out silicon substrate 10. Here, the overlapping part in the dashed box shown in FIG. 4 needs to be removed on the basis of this structure. Since the silicon substrate 10 of the silicon-based integrated electro-optic modulator is covered with one buried layer of silicon dioxide 20, this layer needs to be opened first before the silicon substrate 10 is hollowed out. Further, since the active area 30 of the silicon-based integrated electro-optic modulator is located over the buried layer of silicon dioxide 20, the active area 30 should be protected at the same time of guarantee sufficient mechanical strength when the buried layer of silicon dioxide 20 is opened.

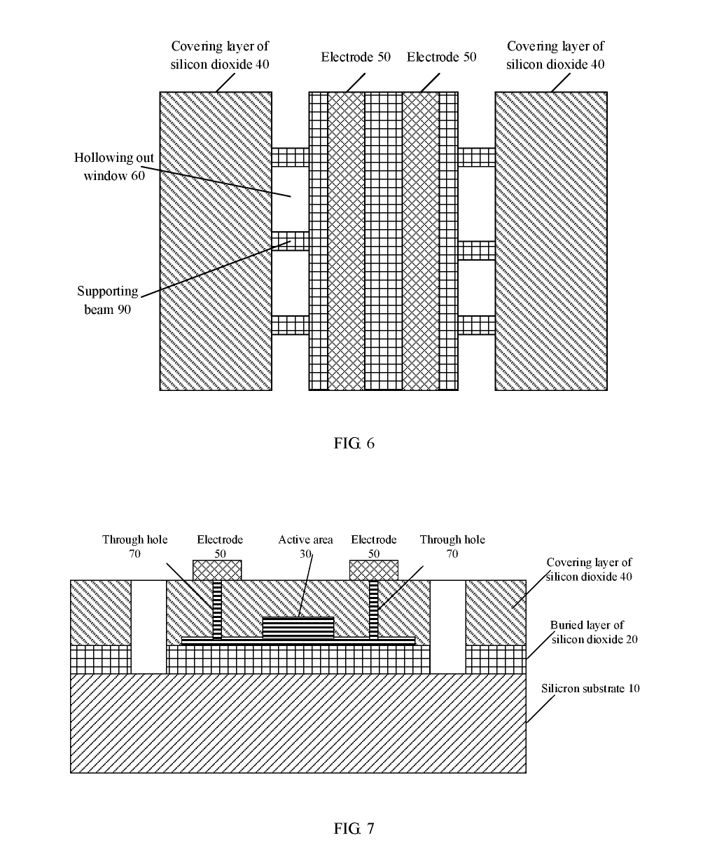

As shown in FIG. 6, it is a top view of hollowing out windows 60 opened in the buried layer of silicon dioxide 20. A non-etched part is left between the hollowing out windows 60 as a supporting beam 90 for supporting and fixing, thereby preventing damage of the silicon-based integrated electro-optic modulator under the action of vibration caused by an external force. The hollowing out windows 60 may be sized so that the structure of the active area 30 and the electrodes 50 is not damaged while the space big enough to hollow out the silicon substrate 10.

As shown in FIG. 7, it is a cross-sectional structural schematic diagram of the part of the opened hollowing out windows 60. The depth of the hollowing out windows 60 requires that the entire buried layer of silicon dioxide 20 is etched through. The depth of the hollowing out windows 60 can get into the silicon substrate 10. After the etching of the hollowing out windows 60 is completed, the hollowing out area 80 is hollowed out via the hollowing out windows 60. During the hollowing process, the silicon substrate 10 needs to be selectively etched. In this way, the silicon substrate 10 can be hollowed out most effectively with no damage to the structure of other layers. Thus, the hollowing of the silicon substrate 10 is completed.

In this solution, the hollowing out windows 60 are formed by using an anisotropic etching process in the buried layer of silicon dioxide 20. Thus, the active area 30 of the silicon-based integrated electro-optic modulator can be protected against damage during the process of opening the hollowing out windows 60. Moreover, the hollowing out windows 60 need to be etched to the part of the silicon substrate 10, which can go beyond, but cannot stop before the part of the silicon substrate 10. That is, the hollowing out windows 60 need to communicate with the hollowing out area 80. The shape and size of the hollowing window 60 may be freely selected, such as square, round, oval, trapezoid, and triangle, as long as enough space to hollow out the silicon substrate 10 can be guaranteed while sufficient mechanical supporting strength is provided. When the silicon substrate 10 is hollowed out, an isotropic etching process or a wet etching process is employed.

The range of hollowing out the silicon substrate 10 is required not to be smaller than the hollowing out area 80 obtained through previous calculation, so that the optimal effect can be produced. The hollowing out area 80 can achieve the effect of improving the 3 dB bandwidth even though the hollowing out area 80 is partially hollowed out. Furthermore, the range of hollowing out the silicon substrate 10 cannot be too large, or otherwise, it may affect the mechanical reliability of the entire silicon-based integrated electro-optic modulator.

The above silicon-based integrated electro-optic modulator is merely an embodiment of the present invention. This solution can be applied to not only silicon-based integrated electro-optic modulators, but also other integrated electro-optic modulator having substrate materials, which will not be redundantly described herein.

1. An integrated electro-optic modulator, comprises a substrate material, a buried layer of silicon dioxide, an active area, a covering layer of silicon dioxide, and two electrodes,
wherein the substrate material is located at the bottom layer and covered with the buried layer of silicon dioxide; the active area is disposed at the center of the buried layer of silicon dioxide; the covering layer of silicon dioxide covers the active area on the buried layer of silicon dioxide; the two electrodes are disposed on the buried layer of silicon dioxide; the active area is shaped like a step with the middle protruding; a plurality of hollowing out windows are etched in the buried layer of silicon dioxide; the two electrodes are connected to the step surface of the active area via two through holes, respectively;
the substrate material comprises a hollowing out area and a non-hollowing out area;
the hollowing out area is an overlapping part of an electric field intensity distribution area on the cross section of a modulation area of the integrated electro-optic modulator and the substrate material, and the rest of the substrate material is the non-hollowing out area.

2. The integrated electro-optic modulator of claim 1, wherein the hollowing out windows are etched by using an anisotropic etching process, and the hollowing out area is hollowed out via the hollowing window using an hollowing out operation.

3. The integrated electro-optic modulator of claim 1, wherein a non-etched part is left between the hollowing out windows as a supporting beam.

4. The integrated electro-optic modulator of claim 1, wherein the hollowing out operation is performed on the hollowing out area by using an isotropic etching process or a wet etching process.

5. The integrated electro-optic modulator of claim 1, wherein the shape of the hollowing out windows includes but is not limited to square, round, oval, trapezoid, and triangle.

6. A method of improving 3 dB bandwidth of an integrated electro-optic modulator by hollowing out a substrate, the method includes the steps of:
calculating an electric field intensity distribution area on the cross section of a modulation area of the integrated electro-optic modulator by electromagnetic field simulation analysis software;
taking an overlapping part of the electric field intensity distribution area and the substrate material as the hollowing out area;
determining a size and positions of the hollowing out windows needing to be opened in the buried layer of silicon dioxide over the hollowing out area beside both sides of the electrodes, and etching out the hollowing out windows; and
performing a hollowing out operation on the hollowing out area via the hollowing out windows.

7. The method of claim 6, wherein the hollowing out windows are etched by using an anisotropic etching process.

8. The method of claim 6, wherein a non-etched part is left between the hollowing out windows as a supporting beam.

9. The method of claim 6, wherein the hollowing operation is performed on the hollowing out area by using an isotropic etching process or a wet etching process.

10. The method of claim 6, wherein the shape of the hollowing out windows includes but is not limited to square, round, oval, trapezoid, and triangle.
